(19) United States
(12) Patent Application Publication
(10) Pub. No.: US 2005/0092516 A1
(43) Pub. Date: May 5, 2005

(54) Flexible cable arranged in rows

(75) Inventors: Yung-Tsai Chuo, Taichung (TW); Chang-Hsin Kuo, Taichung (TW)

Correspondence Address: APEX JURIS, PLLC, 13194 EDGEWATER LANE NORTHEAST, SEATTLE, WA, 98125, US

(73) Assignee: Hiwin Mikrosystem Corp., Taichung (TW)

(21) Appl. No.: 10/985,187

(22) Filed: Nov. 10, 2004

Related U.S. Application Data
(63) Continuation-in-part of application No. 10/414,621, filed on Apr. 16, 2003, now abandoned.

(51) Int. Cl. H01B 7/08

(52) U.S. Cl. 174/117 F

(57) ABSTRACT

The present invention relates to a cable used for electric machinery or mechanical structures, and more particularly to a cable used to transmit the power and voltage signal or transfer the air and oil. The cable has good flexibility and does not need a cable guiding.

The present invention is a continuation-in-part (cip) application of a pending non-provisional patent application with application Ser. No. 10/414,621 filed Apr. 16, 2003.

### BACKGROUND OF THE INVENTION

1. Field of the Invention

This invention relates to an improvement of a cable. For avoiding the winding of the cable, the cable of the present invention includes plural metal conductive wires and pipes (for transferring the air, oil or lubricant) arranged in row. The strength of the cable is reinforced by the steel wires or spring pieces, which have good elasticity, so that the cable can restore after removing the external force to avoid the cable winding for the plastic deformation.

2. Description of the Prior Art

In general, a power machine has a movable part and a fixed part, and the power source is usually set at the fixed part of the power machine, so that the cable for providing power needs not bending or twisting frequently and is less damaged. Therefore, the cable has high reliability. However, based on the requirement of the structure design, the signal checking wire of the location signal is usually connected to the movable part of the machine. Therefore, the signal checking wire is broken easily due to twisting. In some power machines, such as a linear motor, the cable (power cord) for providing power is connected to the movable part for the convenience in power design, so the cable is broken easily as well as the signal checking wire. In addition, in some machines, the pipes for transferring the oil and air are set at the movable part to provide lubricant and reduce friction for the movable part. Therefore, when the movable part and the fixed part are in a complicated movement, the aforesaid wires and pipes are easy to wind around.

FIG. 9 shows a design to avoid the winding of the wires and the pipes. A cable guiding 10 is used to guide the wire and the pipe of the machine, which include the transferring pipe 11 and the cable 12. The transferring pipe 11 can be used to transfer the air, oil or lubricant, and the cable 12 has the insulating material at the exterior side thereof, and plural electric wires in the interior thereof for transferring the voltage signal or electric power. The cable guiding 10 can guide the transferring pipe 11 and the cable 12 to move in a specific path so as to avoid winding. The aforesaid pipe 11 and the cable 12 are independent respectively, and are combined via the cable guiding 10. However, since the cable guiding 10 occupies a big space, the curvature is limited and the machine seems sluggish when moving fast.

Therefore, for the movable part of the conventional machine, the connecting manner of the cable should be improved to avoid the winding of the wires and the pipes, and reduce the break of the wires and pipes.

### SUMMARY OF THE INVENTION

It is an object of the present invention to provide a flexible cable used in the movable part of the moving machine.

It is another object of the present invention to provide a flexible cable which has good flexibility and is hard to wind around, so as to avoid the break of the cable due to bending and twisting.

When the material is bended, the interior of the material will bear a stress and result a strain. As shown in FIG. 10, when the bar is bended, the strain is bigger at the exterior side of the bar, and smaller in the middle line. The stress is increasing with the strain, so that the bending is hard when material with bigger strain. And, it is easy to exceed the elastic limit and results in plastic deformation. Therefore, except to change the material and the winding design of the wire, another way to increase the flexibility is to reduce the thickness of the wire. FIG. 11 shows a conventional cable used to transfer the power or voltage signal. The insulating material 14 covers at the exterior side of the metal conductive wire 13 to prevent the electric leakage. The metal conductive wires 13 of the cable are arranged in row, so that the thickness of the cable in one specific direction is obviously smaller, and therefore the cable has good flexibility. However, the elasticity of such cable is not good, so that the cable cannot restore after removing the external force, although it has good flexibility. Therefore, after the repeated movements of the movable part of the machine, the cable bears a heavy load and results in complicated deformation, and the winding will happen.

For avoiding the winding of the cable, the cable of the present invention includes plural metal conductive wires and pipes (for transferring the air, oil or lubricant) arranged in row. The strength of the cable is reinforced by the steel wires or spring pieces, which has good elasticity, so that the cable can restore after removing the external force to avoid the cable winding for the plastic deformation. Besides, for making the spring piece can keep or recover to a straight line under the external force isn't so large, should the profile of the cross-section of the spring piece be designed to arcuate.

### BRIEF DESCRIPTION OF THE DRAWINGS

The drawings disclose an illustrative embodiment of the present invention which serves to exemplify the various advantages and objects hereof, and are as follows:

FIG. 1 shows the flexible cable arranged in row according to a first embodiment of the present invention;

FIG. 2 shows the flexible cable arranged in row according to a second embodiment of the present invention;

FIG. 3 shows the flexible cable arranged in row according to a third embodiment of the present invention;

FIG. 4 shows the flexible cable arranged in row according to a fourth embodiment of the present invention;

FIG. 5 shows the flexible cable arranged in row according to a fifth embodiment of the present invention;

FIG. 6 shows the flexible cable arranged in row according to a sixth embodiment of the present invention;

FIG. 7 shows the flexible cable arranged in row according to a seventh embodiment of the present invention;

FIG. 8 shows the flexible cable arranged in row according to an eighth embodiment of the present invention;

FIG. 9 shows a conventional design to avoid the winding of the wires and the pipes;

FIG. 10 shows the strain distribution when a bar is bended;

FIG. 11 shows a conventional cable;

FIG. 12 is a schematic view showing a thin plate elastic piece is in a bent state by an external force;

FIG. 13 is a schematic view showing an elastic piece with an arcuate cross section is distorted by an external force;

FIG. 14 is the cross section of FIG. 13 cut along line A-A; and

FIG. 15 is the cross section of FIG. 13 cut along line B-B.

### DETAILED DESCRIPTION OF THE PREFERRED EMBODIMENT

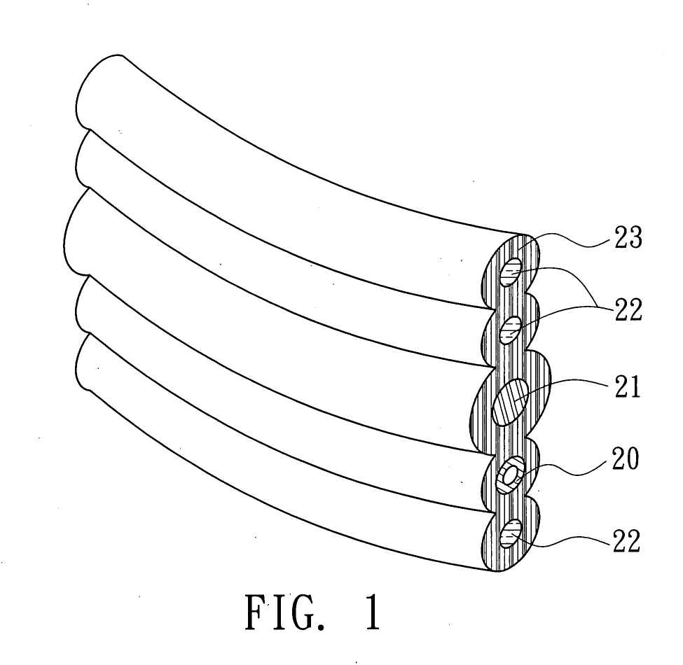

Please refer to FIG. 1 showing the flexible cable arranged in row according to a first embodiment of the present invention. The flexible cable arranged in row includes a pipe 20, a steel wire 21 and a metal conductive wire 22. The aforesaid pipe and wires are arranged in row to reduce the strain or stress generated from the bending of the cable. An insulating material 23 covers at the exterior sides of the aforesaid pipe and wires. In this embodiment, the strength of the cable is reinforced by an elastic piece in the form of a long strip. The elastic piece is a steel wire 21. The pipe 20 is used to transfer the air and fluid, and the metal conductive wire 22 is used to transfer the voltage signal or electric power. In some examples, the pipe 20 for transferring the air and fluid is not needed. Therefore, the pipe 20 is not a necessary element. Since the steel wire 21 reinforces the strength of the cable, the cable can restore after removing the external force below the elastic limit. The row arrangement of the steel wire 21, the pipe 20 and the metal conductive wire 22 make the cable have good flexibility.

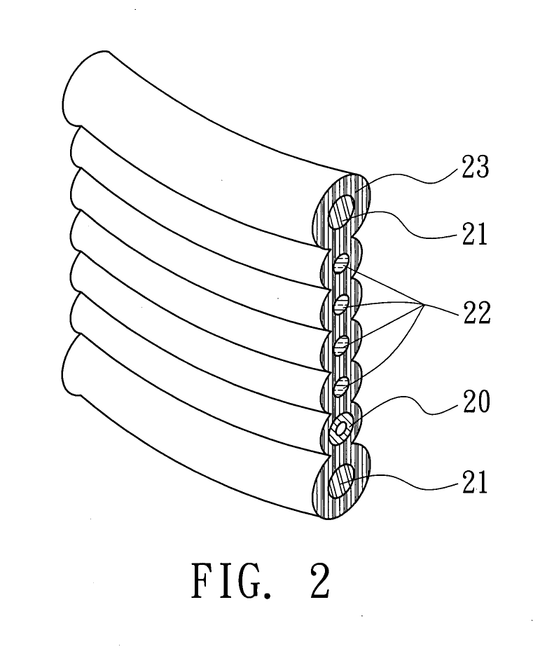

Please refer to FIG. 2 showing the flexible cable arranged in row according to a second embodiment of the present invention. The cable also includes plural metal conductive wires, a pipe and steel wires, and the pipe 20, steel wires 21 and metal conductive wires 22 are arranged in row. The insulating material 23 covers at the exterior sides of the aforesaid pipe and wires, and the two steel wires are arranged at the top and the bottom in the figure. Since the steel wires have good elasticity, when they are arranged at the two sides of the row, the strength of the cable at the two sides can be reinforced. Therefore, when the cable is bended due to the external force, the bending radians at the two sides of the cable are close. There are four metal conductive wires 22 and one pipe 20 in this embodiment, but the numbers of the metal conductive wire 22 and the pipe 20 are changeable in accordance with the actual need.

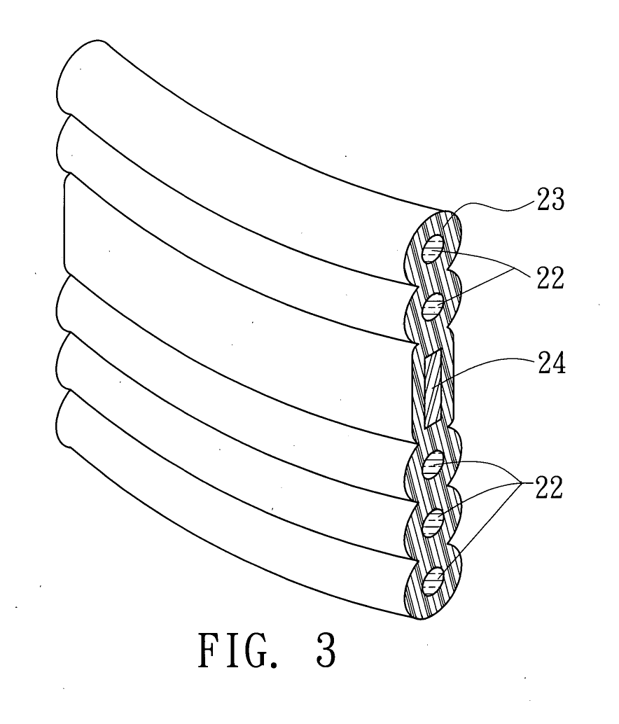

Please refer to FIG. 3 showing the flexible cable arranged in row according to a third embodiment of the present invention. The cable also includes plural metal conductive wires 22. In this embodiment, the strength of the cable is reinforced by an elastic piece, which is a spring piece 24 in the form of a thin slice. The metal conductive wires 22 and the spring piece 24 are arranged in row. The insulating material 23 covers the exterior sides of the aforesaid wires and spring piece. The cross-section of the spring piece 24 is slender. The thinner side of the spring piece 24 is arranged along the thinner side of the cable. Therefore, the flexible cable arranged in row of the present invention has good flexibility, and the bending radians at the two sides of the cable are close. There are five metal conductive wires 22 and no pipe in this embodiment, but the pipe can also be set when needed.

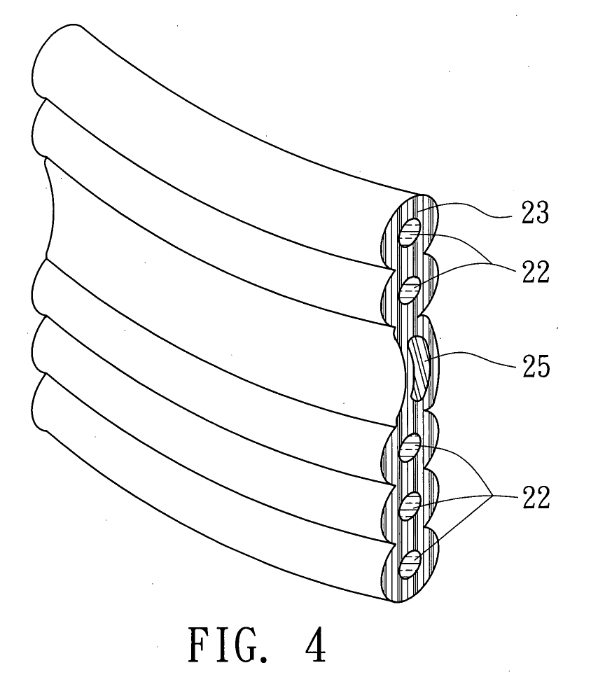

Please refer to FIG. 4 showing the flexible cable arranged in row according to a forth embodiment of the present invention. In this embodiment, the strength of the cable is reinforced by an elastic piece, which is a spring piece 25 having a cross-section of an arc. The arc design of the spring piece 25 can increase the anti-flexibility of the cable, so that the cable is approximately a straight line when it is not bended by the external force. On the other hand, since the spring piece 25 can be designed with a thinner thickness, when the cable has to be bended, the needed bending force can conform the requirement. In this embodiment, the metal conductive wires 22 and the spring piece 25 are arranged in row. The insulating material 23 covers the exterior sides of the aforesaid wires and spring piece. There are five metal conductive wires 22 and no pipe in this embodiment, but the pipe can also be set when needed. The profile of the cross-section of said spring piece 25 be designed to an arc for making the spring piece 25 a straight line under a small external force, but it can be bend easy.

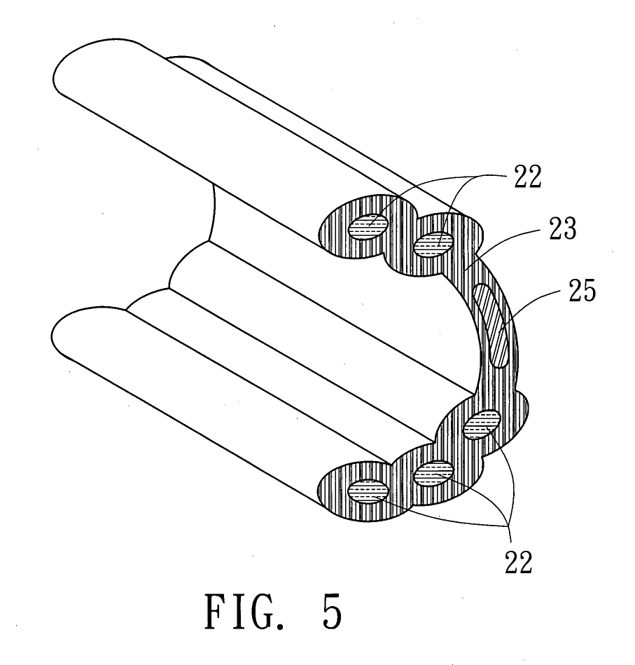

Please refer to FIG. 5 showing the flexible cable arranged in row according to a fifth embodiment of the present invention, which is a modification of the fourth embodiment. The cross-section of the flexible cable is designed to an arc. All the metal conductive wires 22 and the spring piece 25 arrange in an arc. If the bending moment is lower than critical value, the cross-section of the flexible cable be keep arcuate, but the flexible cable bend and the cross-section of the flexible cable become a line when the bending moment exceeds the critical value. This embodiment provides a better anti-flexibility and is desired to keep as a straight line.

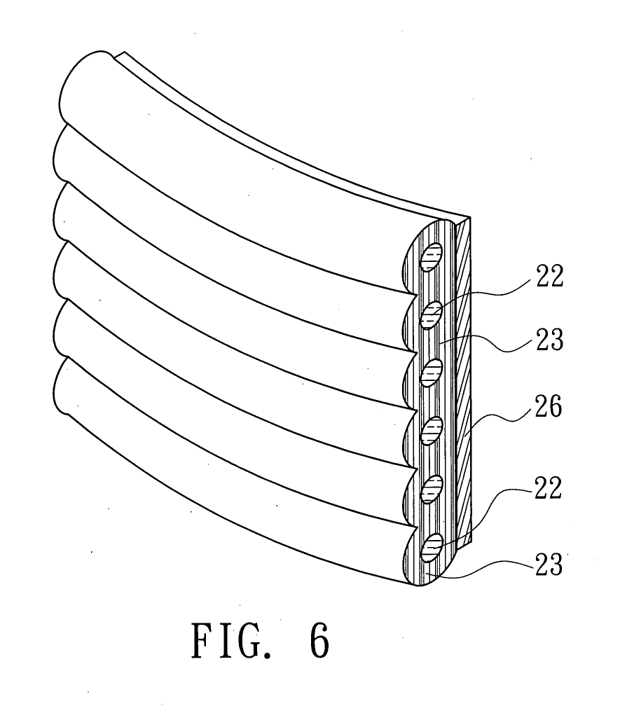

Please refer to FIG. 6 showing the flexible cable arranged in row according to a sixth embodiment of the present invention. The metal conductive wires 22 are arranged in row. The insulating material 23 covers the exterior sides of the aforesaid metal conductive wires 22. The spring piece 26 for reinforcing the strength of the cable is set close to one side of the insulating material 23. The cross-sectional length and width of the spring piece in FIG. 6 are changeable in accordance with flexible elasticity requirement.

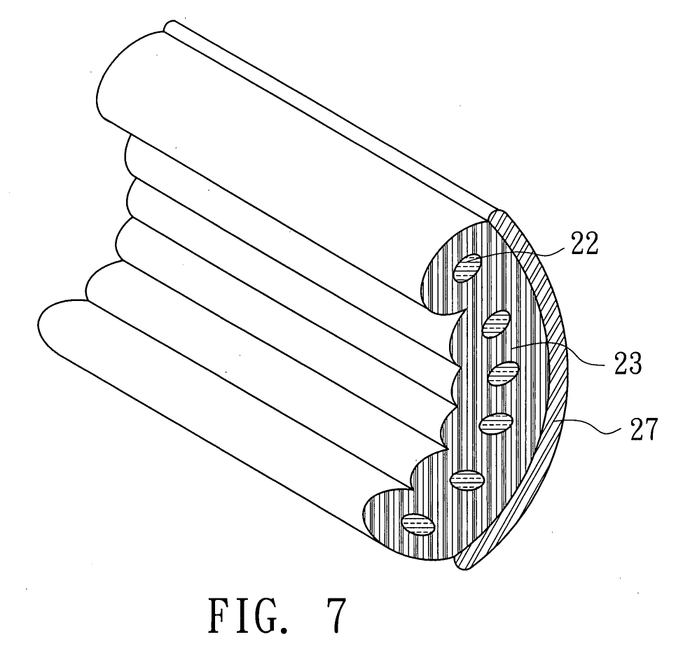

Please refer to FIG. 7 showing the flexible cable arranged in row according to a seventh embodiment of the present invention, which is a modification of the sixth embodiment. In this embodiment, the metal conductive wires 22 are arranged in row but with a small radian. The insulating material 23 covers the exterior sides of the aforesaid metal conductive wires 22. The spring piece 27 for reinforcing the strength of the cable is set close to one side of the insulating material 23. In this embodiment, since the metal conductive wires 22 are arranged in row but with a small radian, and the spring piece 27 is also an arc, the cable has an excellent anti-flexibility.

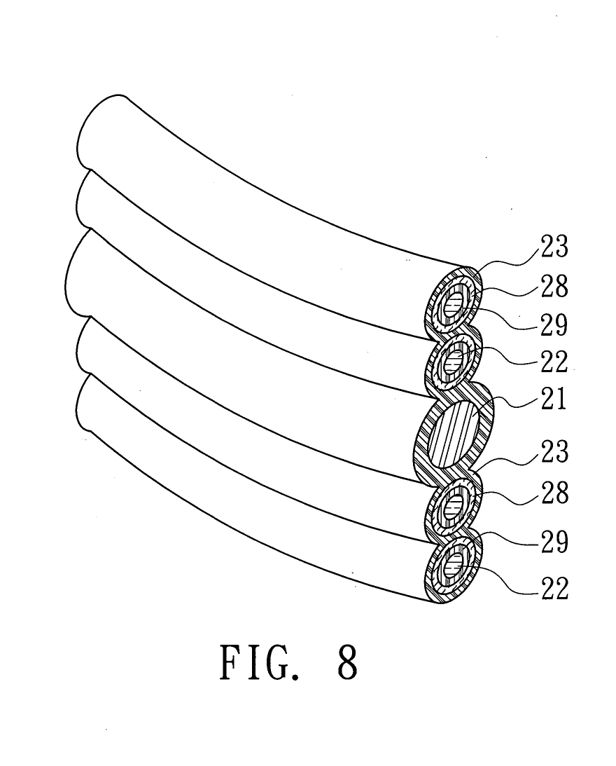

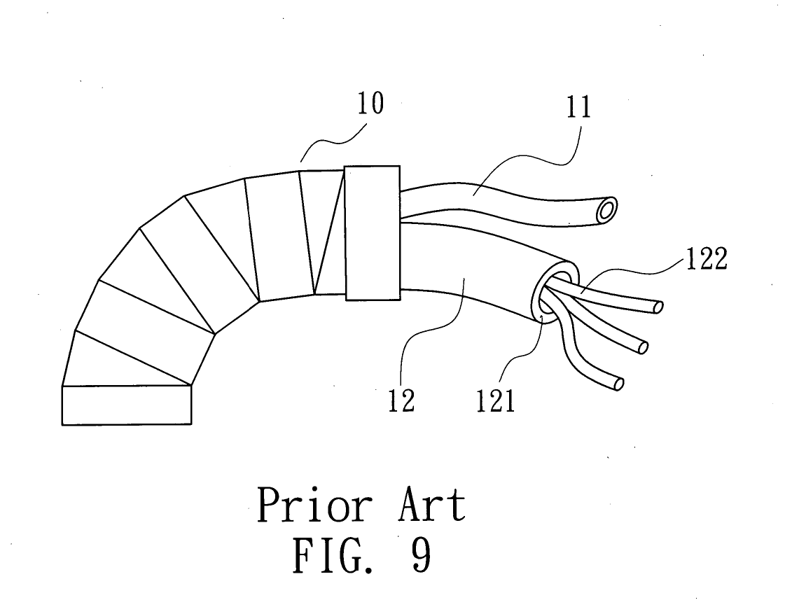

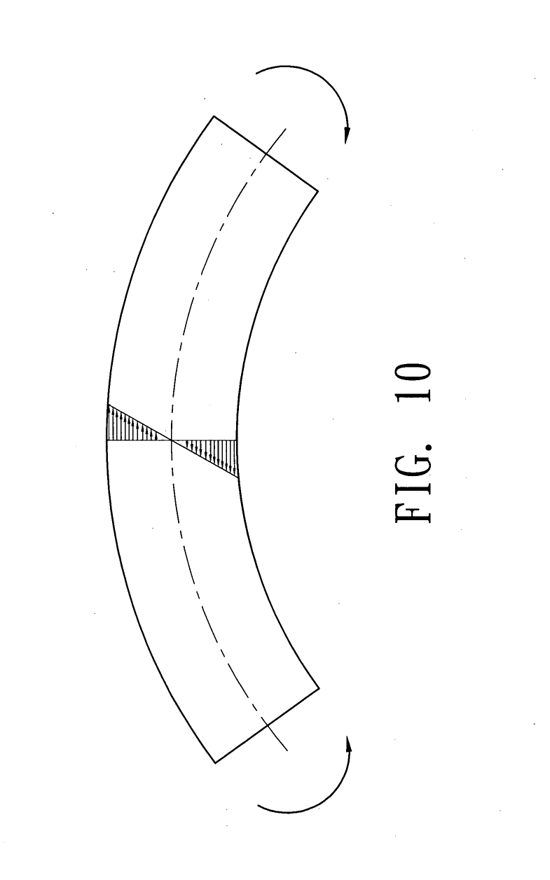

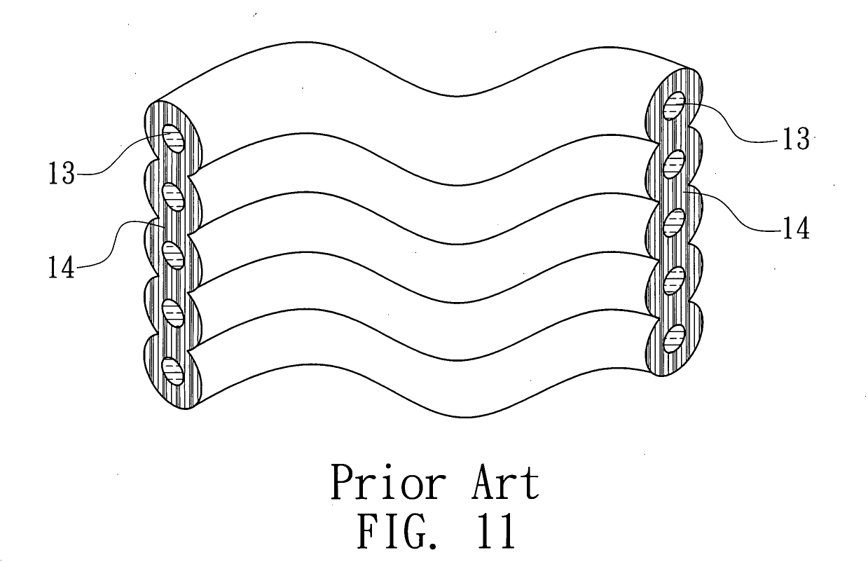

For avoiding the electromagnetic interference, the signal wire is generally covered with a layer of isolated metal net. In addition, the conductive wire for transferring power has a high current value, and causes a strong electric field which may interfere the signal wires in the neighborhood. Therefore, the conductive wire is also generally covered with an isolated metal net to avoid the signal interference. Accordingly, the metal conductive wire 22 in the aforesaid embodiments can be also covered with the isolated metal net. FIG. 8 shows the flexible cable arranged in row according to an eighth embodiment of the present invention. In this embodiment, the metal conductive wire 22 is covered with a layer of insulating material 29, and the insulating material 29 is covered with a layer of an isolated metal net 28, and furthermore, the isolated metal net 28 is covered with the insulating material 26 to avoid the electric leakage.

In order to allow the flexible cable be able to restore its initial state (normally straight) when it is released from an external force, or exerted by a relatively small force so as to avoid crinkling of the cable due to being continuously bent, in the present invention, the elastic piece is designed to configurate into a thin piece having an arcuate cross section.

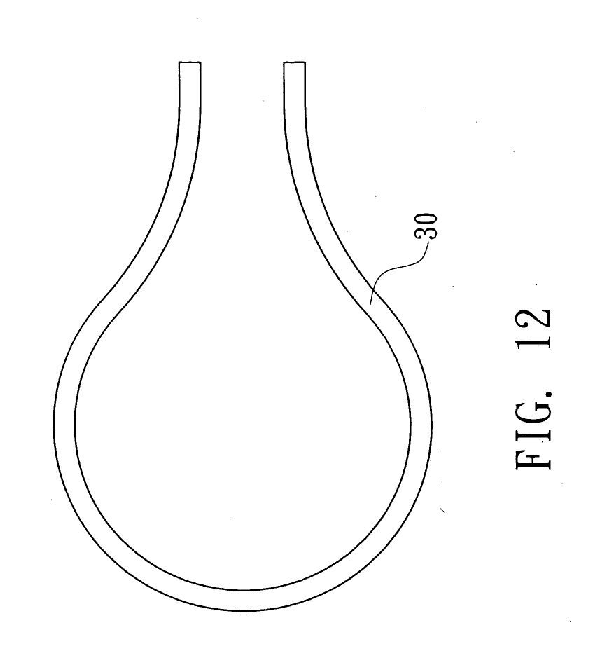

Please refer to FIG. 12, in which a schematic view that a thin plate elastic piece in a bent state by an external force is shown. The thin plate elastic piece 30 is distorted to form a curve of continuously varying curvature through its whole length by applying a bending force from its two ends.

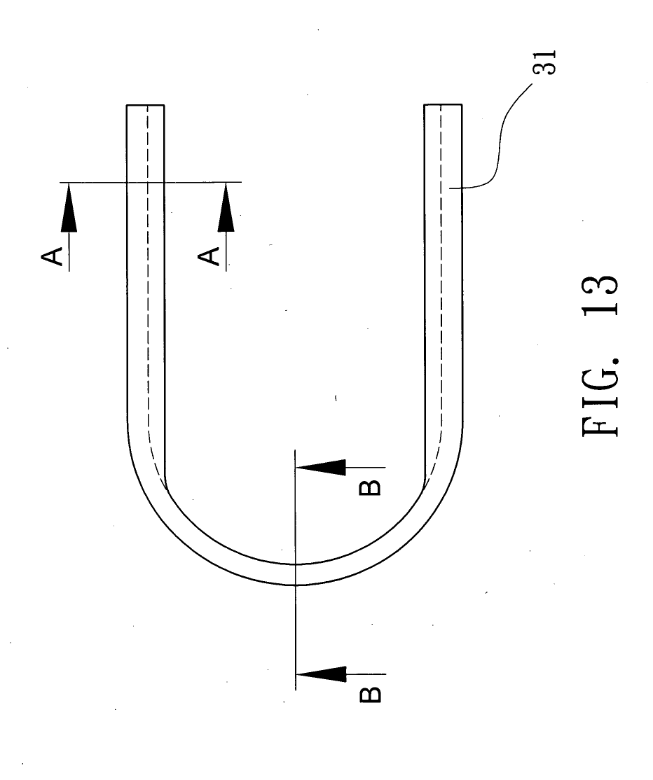

Please refer to FIG. 13, in which a schematic view that an elastic piece 31 with an arcuate cross section is distorted by an external force. The two legs of elastic price 31 are stretched straightly with a semi-circularly curved figure formed in the middle portion.

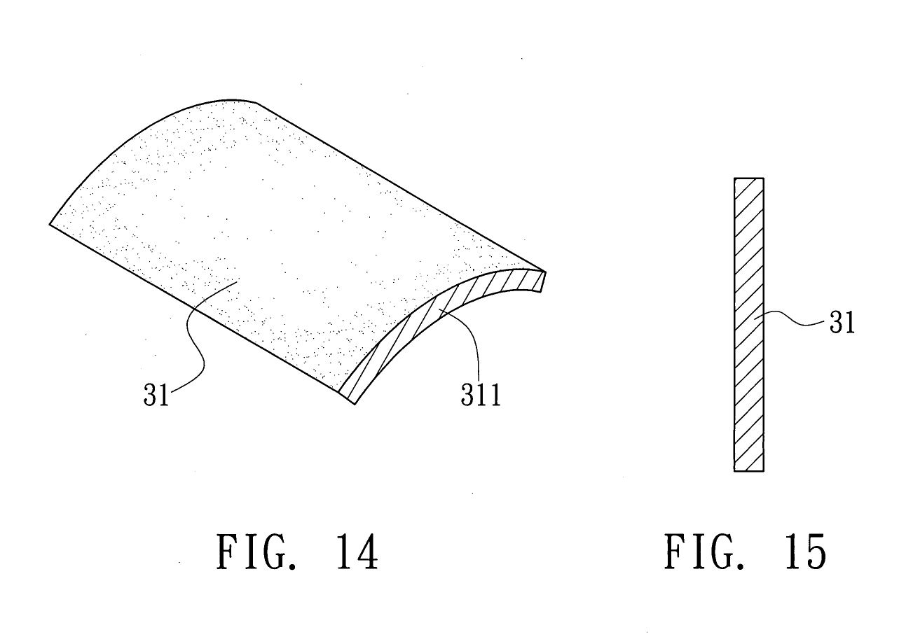

FIG. 14 is the cross section of FIG. 13 cut along line A-A, in which the cross section 311 of the elastic piece 31 is arcuate.

FIG. 15 is the cross section of FIG. 13 cut along line B-B, in which the cross section of the elastic piece 31 which originally is arcuate now becomes straight. The bending moment of an arcuate cross section is significantly larger than an almost straight-shaped cross section of the elastic piece 31 whose distortion stress has not yet reached a critical value. As soon as the torque has reached the critical value, the elastic piece 31 is bent into a semi-circular shape (or arcuate), but at this instant its cross section becomes straight-shaped (FIG. 15). And, then the area of elastic piece 31 with straight-shaped cross section is easy to bend.

Therefore, the flexible cable arranged in row of the present invention has the following advantages:
1. The flexible cable has good flexibility is some specific directions due to the design of row arrangement.
2. The strength of the flexible cable is reinforced by the spring piece or the steel wire. Therefore, the cable will not wind around for the complicated plastic deformation, and the cable guiding is not needed to set outside the cable.
3. The flexible cable includes plural conductive wires and the pipe to comply with the requirements of the movable part of a general machine. In addition, it can be designed to have the function of electromagnetic interference isolation, so it is convenient to be used.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A flexible cable arranged in row, comprising:
plural metal conductive wires being good conductors and arranged in row mutually;
an insulating material covering at an exterior side of said metal conductive wire; and
an elastic piece being a long strip and adjacent to said insulating material, wherein said elastic piece is made of steel and has good elasticity to reinforce the strength of said cable, so that said cable restores after removing the external force below the elastic limit; and the profile of the cross-section of said elastic piece be designed to an arcuate for making said elastic piece a straight line under a small external force.

2. The flexible cable according to claim 1, wherein said spring piece and said metal conductive wires are arranged in a row.

3. The flexible cable according to claim 1, wherein said spring piece is a thin slice and set at one side of said metal conductive wires arranged in rows.

4. The flexible cable according to claim 1, wherein a pipe is set beside said metal conductive wire, and said pipe and said metal conductive wire are arranged in a row.

5. The flexible cable according to claim 1, wherein said metal conductive wire is covered with an isolating metal net.
